(19) United States
(12) Patent Application Publication
(10) Pub. No.: US 2006/0121266 A1
(43) Pub. Date: Jun. 8, 2006

(54) Porous SiC-bodies with micro-channels and process for their fabrication

(76) Inventors: Marco Fandel, Markdorf (DE); Karl-Heinz Thiemann, Korb (DE); Christian Wilhelmi, Friedrichshafen (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 11/289,962

(22) Filed: Nov. 30, 2005

(30) Foreign Application Priority Data
Dec. 2, 2004 (DE) 10 2004 058 119.3

(51) Int. Cl. B32B 3/12; B32B 3/00; C04B 33/32; C04B 33/36; B28B 1/00

(52) U.S. Cl. 428/312.6; 264/610; 264/682; 264/629; 428/312.2; 428/116

(57) ABSTRACT

Process for the fabrication of porous bodies mainly constituted by SiC containing ceramic with a microstructure which is interfused with micro-channels which consists of the process steps a) Provision of a pre-body made from cellulose or pulp b) Fabrication of an infiltration solution or a slurry consisting of (A) solvent, polysilazane, polysilane and/or polycarbosilane or (B) solvent, polysilazane and/or polysilane as well as active metallic fillers and/or passive ceramic fillers. c) Infiltrating the body with infiltration solution or slurry d) Cross-linking of the polysilazane, polycarbosilane and/or polysilane while generating a solid green body e) Ceramization through pyrolysis of the green body in an inert-gas atmosphere. f) Removal of residual carbon with an oxidizing thermal process, thereof producible catalyst carriers or carbon particulate filters as well as Porous ceramic which is made from at least 80% SiC in which the porous ceramic features a microstructure with micro-channels consisting mainly of SiC coated micro-channels featuring an average diameter between 1 and 25 μm and webs of SiC located between the micro-channels as well as additional ceramic materials with a content below 20 wt %.

### BACKGROUND OF THE INVENTION

1. Field of the invention

The invention relates to a process for the fabrication of porous ceramic SiC-bodies with a tubular microstructure or, as the case may be, micro-channels, catalyst carriers or carbon particulate filters producible thereby, as well as porous ceramic SiC-bodies.

2. Related Art of the invention

Carrier materials for carbon particulate filters and catalysts in the field of exhaust gas treatment of motor vehicles are often made from cordierite or silicon carbide (SiC). The fabrication entails a complex and highly wearing extrusion molding process of formable ceramic matter. Although cordierite is a low cost raw material it exhibits, compared to the more recently investigated SiC, a lower specific surface area, a higher mass, and is thermally by far not as stable.

In DE 3926077 A1 a ceramic composite body is disclosed which is made from a matrix which contains inclusions of hard material particulates and/or other reinforcing components, which is fabricated by subjecting a mixture of a silicon-organic polymer with a metallic filler to pyrolysis and a reaction-process in which the metallic filler reacts with the decomposition products of the polymer compounds from the pyrolysis. Because of the achievable high densities and the resulting superior mechanical and thermal properties, these ceramic molds are well suited as high temperature and wear resistant ceramic compounds and for use in parts which are exposed to high mechanical and thermal loads, e.g. machine construction.

In EP 0 412 428 B1 a ceramic composite body is disclosed comprising a matrix with inclusions of hard material particulates and/or other reinforcing components, which is fabricated by treating a mixture of a silicon-organic polymer and a metallic filler to pyrolysis and a reaction-process in which the metallic filler reacts with the decomposition products of the polymer compounds from the pyrolysis. The ceramic compound body features a single- or multi-phase, amorphous, semi-crystalline or crystalline matrix of silicon carbide (SiC), silicon nitride (Si₃N₄), silicon dioxide (SiO₂) or mixtures thereof such as from e.g. oxycarbides, oxynitrides, carbonitrides and/or oxycarbonitrides.

In WO 2002/040424 A1 the fabrication of a honeycomb structure from SiC is disclosed which is suited for use, for instance, in exhaust gas systems of motor vehicles. The porous material features through-holes along the longitudinal axis of the body. The process includes the fabrication of a formable matter from organic binder, silicon and SiC particulates as well as their extrusion into a honeycomb structure. Calcination and sintering thereof follow. The Si content of the material is preferably between 10% and 40% of the sum of Si and SiC.

The fabrication methods discussed still need improvement with regard to enlarged open porosities and larger specific surface areas. The extrusion processes, in contrast, cannot in principle be further improved in regard to the geometrical variety and the fineness of the structure.

### SUMMARY OF THE INVENTION

The objective of the invention is to create a fabrication method for light weight and highly gas permeable bodies made from SiC ceramic with a large effective internal surface area and good filtering performance, which is suitable for catalyst carriers or filters/carbon particulate filters, in which the process is suitable for a cost efficient fabrication of geometrically complex and three dimensional structures.

The objective is accomplished by a process for the fabrication of porous bodies of mainly SiC-containing ceramic which features a mainly tubular gas permeable microstructure as well as by a porous ceramic which contains at least 80% SiC.

A first aspect of the invention relates to a process for the fabrication of porous bodies of mainly SiC-containing ceramic which features a mainly tubular gas permeable microstructure which consists of the following main process steps:
a) Provision of a pre-body made from cellulose or pulp.
b) Fabrication of an infiltration solution or a slurry consisting of
(A) solvent, polysilazane, polysilane and/or polycarbosilane or
(B) solvent, polysilazane and/or polysilane as well as active metallic fillers and/or passive ceramic fillers.
c) Infiltrating the body with infiltration solution or slurry.
d) Cross-linking of the polysilazane, polycarbosilane and/or polysilane while generating a solid green body.
e) Ceramization through pyrolysis of the green body in an inert-gas atmosphere.
f) At least partial removal of residual carbon with an oxidizing thermal process.

The process according to the invention accomplishes the objective of high gas permeability and porosity by building the SiC-body around a support structure from cellulose fibers or, as the case may be, carbonized cellulose fibers, and subsequent oxidative removal of said fibers. Thus, microscopically small gas-permeable channels with a large surface are produced in a SiC body.

A major advantage of the process according to the invention is the low cost of the raw material, which is cellulose or pulp. Another advantage is the simple and versatile shape-forming of the cellulose raw material. In particular, the cellulose raw material already contains the pre-form of the micro-channels, which need to be formed later on, in form of the cellulose fibers. These are not influenced, or worse, destroyed, during the forming process. The macroscopic geometry of the porous SiC containing ceramic body results from the geometry of the cellulose pre-body in which during the ceramization shrinkages in x-, y- and z-direction of up to 55% occur.

The composition of the SiC body is easily modifiable through the type of infiltration solution or slurry.

### BRIEF DESCRIPTION OF THE DRAWINGS

The invention will be described in greater detail on the basis of the following figures. They show:

FIG. 1 Structural formula of a preferred polysilazane

FIG. 2 SEM picture of raw cellulose

FIG. 3 SEM picture of a fractured surface of SiC body fabricated according to the invention

FIG. 4 Schematic diagram of the process according to the invention

FIG. 5 Plate shape structured SiC body

FIG. 6 Cylindrical SiC body

### DETAILED DESCRIPTION OF THE INVENTION

In a first step the process according to the invention consists of (a) the provision of a pre-body made from cellulose or pulp. The choice of the cellulose or pulp material depends in particular on fiber architecture, carbon rate of yield, low annealing or ash residues, low alkali-/earth-alkali metal content as well as decomposition and shrinkage behavior.

Typically the pre-body is made from paper or cardboard with high pulp content. It is essential for the body, that it has a high content of fibrous pulp or cellulose. A high content of relatively long pulp fibers is advantageous.

In principle various known forming methods for paper may be utilized for the fabrication of the pre-body. For instance, a cylindrical body is easily fabricated by multiple turn coiling. Here flat and corrugated layers can alternate. The body from cellulose or pulp usually contains additional additives which predominantly serve the mechanical stabilization of the body such as, for instance, adhesives or organic impregnators.

Also, it is possible to convert the paper with water into a mash which is then formed. This is also valid for the usual paper precursors and raw materials.

Hence the process used in the invention is a simple and cost efficient process, providing high degrees of freedom with respect to the geometrical shape and the fabrication of geometrically complex SiC structures.

Preferably cellulose materials are used with a fiber diameter below approximately 150 μm. Preferably the average fiber diameter, i.e. the average of the diameters of all fibers, of the cellulose fibers is in the range of 1 μm to 90 μm, particularly preferred in the range of 5 μm to 20 μm. This range represents a good compromise between a large surface, sufficient strength and the requirement for a minimum pressure loss for the gas flowing through the SiC body. FIG. 2 shows a typical micro-structure for cellulose materials.

In a further embodiment of the invention cellulose material is utilized in which the cellulose fibers in average are aligned in a preferred direction. Another advantage of the raw materials according to the invention, namely paper or cardboard, is that the cellulose fibers already exhibit a texture. This texture is found later on in the corresponding micro channels of the SiC body.

In another advantageous embodiment of the invention the cellulose material or, as the case may be, the pulp is arranged such that a preferred alignment of the cellulose fibers forms parallel to the longitudinal axis of the body they constitute.

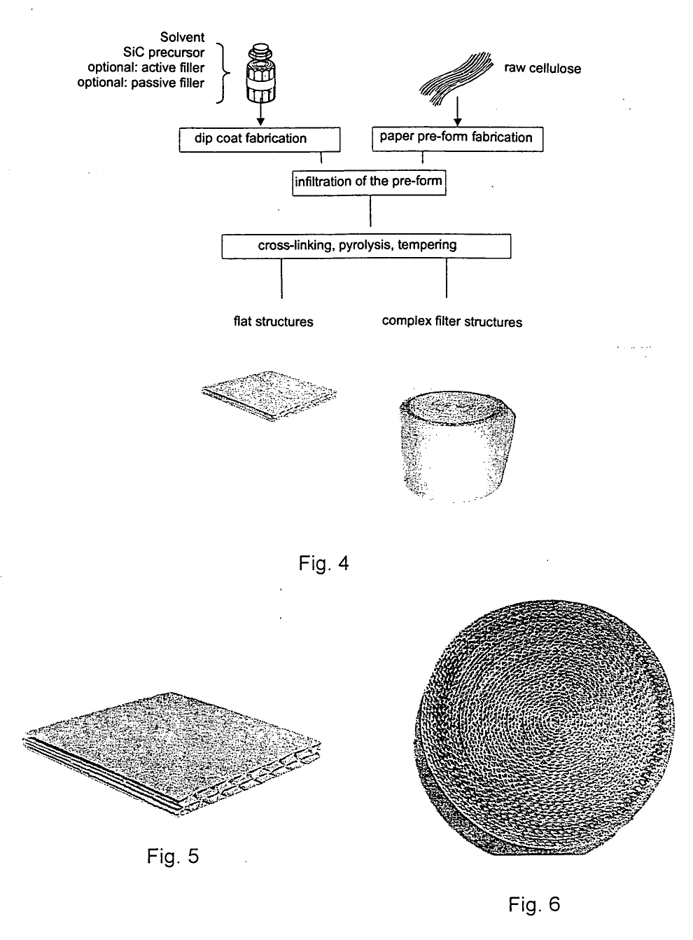

For the infiltration of the cellulose body/pulp body, in an additional process step (b) an infiltration solution or a slurry is provided which consists of (A) solvent, polysilazane, polysilane and/or polycarbosilane or (B) solvent, polysilazane and/or polysilane as well as active metallic fillers and/or passive ceramic fillers (compare FIG. 4).

Major component of the infiltration solution is the silicon-organic polymer of polysilazane, polysilane and/or polycarbosilane which can form SiC and/or Si₃N₄ by means of pyrolysis. These silicon-organic compounds aren't highly cross-linked polymer materials but rather partly cross-linked polymer or oligomer materials. Of essence is that the compounds can be dissolved with organic solvents into low to highly concentrated solutions.

Here polysilanes, polycarbosilanes and polysilazanes with a high ceramic rate of yield are particularly preferred.

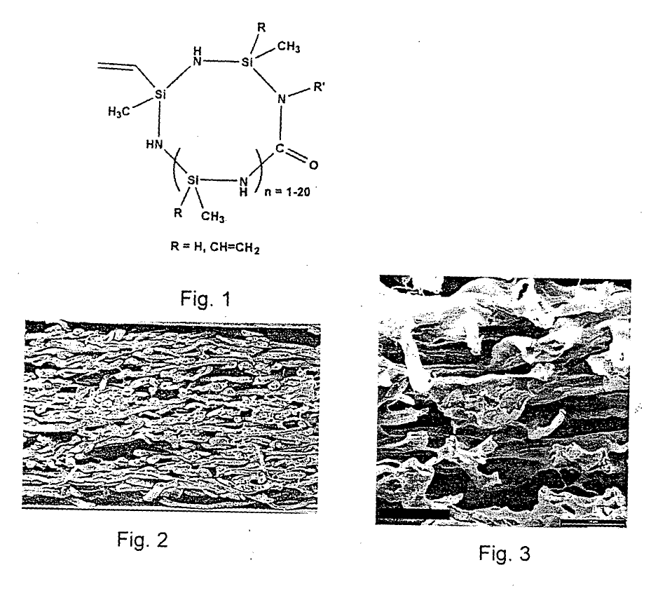

Polysilanes, polycarbosilanes or polysilazanes are in principle known to the expert. Among the particularly suitable polysilazanes are cyclic compounds according to the structural formula in FIG. 1.

In a first embodiment of the invention an infiltration solution (A) is constituted mainly by polysilazanes, polycarbosilane and/or polysilanes (Si-oligomers) and solvent. As additional components cross-linkingor, as the case may be, polymerization catalysts for the formation of highly molecular Si-polymers (Polysilane, -carbosilane, -silazane) may be added to the infiltration solution. Suitable catalysts are in particular peroxides as they are known from the polymer chemistry. Preferred between 0.1 and 5 wt % of an organic peroxide is added as thermal catalyst.

Among the preferred solvents are hydrocarbons (aliphatic and aromatic compounds), ether, ester or ketones. Particularly preferred solvents are xylol, dibuthylether, n-buthylacetate, ethylacetate and tetrahydrofurane. The boiling point of the solvent is preferably in the range between 70 and 150° C. The solvents are preferably water-free. The concentration of the solvent is mainly determined by the viscosity of the infiltration solution which is suitable for the infiltration as well as the requirements and applications of the resulting SiC containing ceramic.

In a further variant (B) additional solid materials in form of particulates are added to the infiltration solution forming a slurry. These solid materials are active metallic or passive ceramic fillers. The solid particulates need to be chosen fine preferably with an average particulate size below 5 μm.

The term active in this context means that the filler is suitable for a reaction with the ceramic phases, especially carbon, which are formed in the process step (e). Among the fillers which are suitable according to the invention are amongst others Si, B, Ti or Zr. Those are suitable for a reaction with carbon to the corresponding carbides or in the case of the Ti or Zr additionally for the formation of silicides.

Suitable passive ceramic fillers amongst others are SiC, TiC or TiN.

The content of fillers is preferably below 25 wt % of the slurry. Preferably Si is utilized as active filler with a content of 0 to 25 wt %.

Preferred slurry compositions are as follows:
Xylol: 20 to 90%
Polysilazane: 10 to 80%
Si: 0 to 25%
SiC: 0 to 10%

In the following process step (c) the infiltration of the cellulose body takes place with the infiltration solution or the slurry. Since the silicon-organic polymers are usually sensitive to oxidation or hydrolysis, this step is preferably done in an inert-gas atmosphere or in vacuum. The infiltration for instance can be performed by a simple dip coating process under inert gas conditions.

In the following process step (d) the cross-linking of the silicon-organic polymer takes place while a green body is formed. It is essential that the silicon-organic compounds are cross-linked to a degree that they can't melt anymore. The cross linking can be promoted thermally, catalytically and/or through cross-linking enhancers. Preferred methods are cross linking under the influence of peroxide-catalysts, cross-linking through water, cross-linking through water vapor or, if the geometry allows, a light-induced cross linking, e.g. by exposure to UV-light.

The thermal cross linking with peroxide catalysts is preferably performed in a nitrogen atmosphere within a temperature range between 110 and 180° C.

The result of this process step is a mechanical stable cellulose body or pulp body which in the following is also called green body.

In the following process step (e) the ceramization of the green body by pyrolysis takes place in an inert-gas atmosphere. Here particularly the cellulose fibers are carbonized and the silicon-organic compounds are transformed into the respective ceramics SiC and Si₃N₄. To a lesser degree the Si from the Si-polymers reacts with the carbon of the cellulose fibers.

Preferably polysilazanes and processes are chosen such that during the ceramization predominantly SiC and only small amounts of Si₃N₄ are formed. The predominantly formed reaction product depends especially on the molecular structure of the polysilazanes, the inert gas and the ceramization temperatures.

Also the active fillers react, particularly by forming carbides and/or silicides. For the case Si powder is added to the infiltration slurry, it reacts with the cellulose carbon or the polymer carbon forming SiC.

As a preferred thermal treatment for the ceramization the material is pyrolized in an oven at an ultimate temperature of 1400 to 1700° C. In the oven the process takes place in an inert gas atmosphere, in particular with Ar or N₂, or under vacuum.

Besides the corresponding silicon-ceramics, the ceramized body includes a high content of carbonized cellulose or, as the case may be, paper, which is referred to as residual carbon. The content of residual carbon may be up to 40 wt % of the ceramized body.

It is essential that the residual carbon has adopted the fibrous structure of the cellulose body.

Since the green body shrinks differently depending on the material, paper thickness and ceramization method, the paper form or, as the case may be, the cellulose body, are preferably fabricated oversized. The shrinkage for planar parts may be as much as 15 to 35% in the x- and y-direction and 15 to 55% in the z-direction. 3-D parts usually exhibit a very complex shrinking behavior which is preferably taken into account by adjusting the dimensions of the paper or cellulose body. Cylindrical paper coils, like the one shown in FIG. 6, after ceramization and burnout of the residual carbon, shrink depending on the actual coiling method and ceramization temperature between 20 and 30% in height and between 20 and 28% in diameter. The dimensions of the pre-body or pre-form are preferably enlarged accordingly.

In the subsequent process step (f) the residual carbon is at least partially removed with an oxidizing thermal process (burnout). For this the ceramic body is tempered in air, preferably at temperatures between 500 and 800° C.

The tempering comes along with a weight loss through the combustion of carbon but not with a change in structure. The result in fact is a stable, non deformable and porous SiC body, with a micro structure which reflects the fibrous structure in the cellulose or in the paper pre-body. Thus in this process step open pores, channels or micro-channels are formed which constitute the major part of the microstructure. These channels are internally coated with the corresponding silicon-ceramic phases from the ceramizing step. Between the channels the microstructure features webs and globular material.

A typical microstructure as it is obtained in a SiC body with the process according to the invention is show in FIG. 3.

During the burnout the content of the carbon, i.e. free carbon, is preferably reduced to values below 15 wt %, particularly preferred to values below 5 wt %. Values below 1 wt % or, as the case may be, the complete removal of the residual carbon, are desirable but require typically a very long burnout process.

The porous SiC bodies with micro-channels according to the invention are particularly suitable as catalyst carrier or carbon particulate filter as they are utilized especially for the exhaust gas treatment for motor vehicles.

The burnout of the carbon according to main process step (f) is not necessarily restricted to one single process step; it may well be a sequence of sub-processes. As the case may be, this process step may be performed or continued during the operation of the porous SiC body as a carbon particulate filter or a catalyst carrier. Thereby the carbon content drops continuously through the operation as carbon particulate filter or catalyst carrier in a hot exhaust gas stream down to 0 wt %.

For the fabrication of catalysts it is necessary to coat the SiC bodies according to the invention with an active catalyst material. For this, a metal containing catalyst, particularly Pt—, Ag—, and/or Pd-containing catalysts, are preferably directly subsequently to the tempering coated onto the SiC surface. Depending on the size of the utilized coating materials a smaller or larger portion is deposited in the micro-channels. Through the tempering, the SiC body has an activated surface which in comparison coats well with the metallic catalysts or, as the case may be, oxidized catalyst carriers.

A preferred embodiment of the carbon particulate filter or catalyst carrier according to the invention features a porosity-gradient perpendicular to the longitudinal axis. Through this, for instance, the thermal budget of the filter or catalyst can be influenced in an advantageous manner. This is particularly the case for a cold start of a motor vehicle.

It may be of advantage to configure the outer region of the catalyst with a higher porosity than the center. Thus, in its outer region the catalyst achieves a better thermal insulation at lower catalytic activity.

Another aspect of the invention relates to a porous ceramic which is made from at least 80% SiC and features a microstructure which is interfused with micro-channels. The SiC micro-channels feature an average pore diameter between 1 and 25 μm.

The porosity is mainly based upon open pores and is constituted by channel-shaped and differently shaped pores. The average pore diameter of the porous ceramic is 30 to 90 μm.

The porous ceramic preferably features a geometric density in the range between 0.10 and 1 g/cm³. Thereby the open porosity is preferably in the range between 40 and 85% and the specific surface area in the range of 1 to 40 m²/g.

Porous SiC ceramic bodies according to the invention are shown in FIG. 5 and FIG. 6.

In a particularly preferred embodiment the micro-channels are in average aligned in a preferred direction. The length of the channels is in average preferably at least 5 times of the corresponding channel diameter.

Besides SiC the porous ceramic may contain additional ceramic material with a content below 20 wt %. Among these materials, which are found predominantly between the channels, are mainly Si₃N₄, carbon, TiC, TiN and/or SiO₂. Carbon in this context is the free carbon. Preferably the content of these additional materials is chosen in the range of 5 to 10 wt %, especially for TiC, TiN or SiO₂.

In a preferred embodiment of the invention the carbon content is below 5 wt %, particularly preferred below 1 wt %.

1. A process for the fabrication of open-pored porous bodies mainly constituted by SiC-containing ceramic with a microstructure which is interfused with micro-channels, comprising:
a) provision of a pre-form made from cellulose or pulp;
b) preparation of an infiltration solution or a slurry consisting of
(A) solvent, polysilazane, polysilane and/or polycarbosilane or
(B) solvent, polysilazane and/or polysilane, as well as active metallic fillers and/or passive ceramic fillers;
c) infiltrating the body with infiltration solution or slurry;
d) cross-linking the polysilazane, polycarbosilane and/or polysilane to generate a solid green body;
e) ceramization through pyrolysis of the green body in an inert-gas atmosphere; and
f) at least partial removal of residual carbon with an oxidizing thermal process.

2. The process according to claim 1, wherein
the content of free carbon is reduced below 15 wt % by an oxidizing thermal process.

3. The process according to claim 1, wherein
the pre-body is made from paper with a mass per unit area of between 80 and 1200 g/m².

4. The process according to claim 1, wherein
a cellulose or pulp material is chosen in which the average fiber diameter of the cellulose fibers is between 1 and 90 μm.

5. The process according to claim 1, wherein
the fabrication of the pre-body into a cylindrical body is done by coiling of paper.

6. The process according to claim 1, wherein
the cellulose fibers in average exhibit a preferred alignment parallel to the longitudinal axis of the body they constitute.

7. The process according to claim 1, wherein
as polysilazane a cyclic polysilazane is chosen.

8. The process according to claim 1, wherein
0.1 to 5 wt % of an organic peroxide is added as a catalyst to the solution or slurry for the thermally induced cross linking of the silanes or silazanes.

9. The process according to claim 1, wherein
Si and/or Ti are added to the slurry as active ceramic filler.

10. The process according to claim 1, wherein
SiC, TiC or Si₃N₄ are added to the slurry as passive ceramic filler.

11. The process according to claim 1, wherein
subsequent to process step f) metal containing catalysts, in particular Pt—, Ag— and/or Pd-containing catalysts, are coated onto the SiC surface.

12. A catalyst carrier or carbon particulate filter characterized by open-pored porous bodies mainly constituted by SiC-containing ceramic with a microstructure which is interfused with micro-channels, said carrier or filter fabricated by a process comprising
a) provision of a pre-form made from cellulose or pulp;
b) preparation of an infiltration solution or a slurry consisting of
(A) solvent, polysilazane, polysilane and/or polycarbosilane or
(B) solvent, polysilazane and/or polysilane, as well as active metallic fillers and/or passive ceramic fillers;
c) infiltrating the body with infiltration solution or slurry;
d) cross-linking the polysilazane, polycarbosilane and/or polysilane to generate a solid green body;
e) ceramization through pyrolysis of the green body in an inert-gas atmosphere; and
f) at least partial removal of residual carbon with an oxidizing thermal process.

13. The catalyst carrier according to claim 12, wherein
the porosity exhibits a gradient perpendicular to the longitudinal axis of the carbon particulate filter or catalyst carrier.

14. A porous ceramic comprising at least 80% SiC, wherein
the porous ceramic features a microstructure which is interfused with micro-channels consisting mainly of SiC micro-channels featuring an average pore diameter between 1 and 25 μm and webs of SiC located between the micro-channels as well as additional ceramic materials with a content below 20 wt %.

15. The porous ceramic according to claim 14, wherein the micro-channels in average exhibit a preferred alignment direction.

16. The porous ceramic according to claim 14, wherein
the additional ceramic materials are Si₃N₄, carbon, TiC, TiN and/or SiO₂.

17. The porous ceramic according to claim 14, wherein
the open porosity is between 40 and 85%.

18. The porous ceramic according to claim 14, wherein
the content of carbon is below 5 wt %.
